(19) United States
(12) Patent Application Publication
(10) Pub. No.: US 2010/0079216 A1
(43) Pub. Date: Apr. 1, 2010

(54) ADAPTIVE EQUALIZER CIRCUIT

(75) Inventor: Yoshihisa SAKANO, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/562,449

(22) Filed: Sep. 18, 2009

(30) Foreign Application Priority Data
Sep. 29, 2008 (JP) 2008-249757
Sep. 29, 2008 (JP) 2008-249759
Aug. 7, 2009 (JP) 2009-184546

(51) Int. Cl. H01P 1/00; H04B 3/14

(52) U.S. Cl. 333/2; 333/28 R

(57) ABSTRACT

An equalizer amplifies a predetermined bandwidth of an input signal with an adjustable gain. A driver amplifies an output signal S1 of the equalizer, and outputs the signal thus amplified. An amplifiers amplifies the output signal S1 of the equalizer. A first high-pass filter allows a predetermined bandwidth of the output signal of the equalizer to pass. A second high-pass filter allows a predetermined bandwidth of the output signal of the amplifier to pass. A first error amplifier amplifies the difference between the output signals of the first high-pass filter and the second high-pass filter so as to generate an error signal, and controls the gain of the equalizer according to the error signal thus generated. The amplifier has a configuration in which a single-stage differential amplifier employing MOSFETs is arranged. An adjustment resistor is provided between the drains of the differential transistor pair in order to increase the bandwidth.

### BACKGROUND OF THE INVENTION

1. Field of the Invention

The present invention relates to an equalizer which performs waveform-shaping of differential signals.

2. Description of the Related Art

In recent years, the HDMI (High-Definition Multimedia Interface) standard which allows video signals and audio signals to be transmitted/received at high speeds among digital appliances such as TV sets, DVD (Digital Versatile Disc) players, and AV amplifiers, has begun to come into commonplace use. The HDMI allows video signals, audio signals, and control signals to be transmitted via a signal cable using differential signals.

In a case in which there is a great distance between the devices connected according to the HDMI, such an arrangement requires a long cable. This leads to a problem in that the waveform of the differential signals is dulled due to transmission of the differential signals via such a long cable, resulting in an increased error rate.

In order to restore a differential signal having degraded quality due to signal transmission, an equalizer which enhances or attenuates a particular frequency component of the differential signal is provided. Furthermore, an adaptive equalizer circuit has been proposed, which adaptively changes the gain of the equalizer according to the degree of degradation in the input differential signal (see Non-patent Document 1).

### Related Art Documents

### [Patent Documents]

### [Patent Document 1]

PCT Japanese Translation Patent Publication No. 2005-511214

### [Non-Patent Documents]

### [Non-Patent Document 1]

Jong-Sang Choi, Moon-Sang Hwang, Deog-Kyoon Jeong, “A 0.18-μm CMOS 3.5-Gb/s Continuous-Time Adaptive Cable Equalizer Using Enhanced Low-Frequency Gain Control Method”, IEEE JOURNAL OF SOLID STATE CIRCUITS, VOL. 39, NO. 3 MARCH 2004, pp 419-425
1. The adaptive equalizer circuit feedback-controls the gain of the equalizer. With HDMI, data is transmitted at a high bit rate in the form of differential signals, and if the bandwidth of the feedback loop is narrow, such an arrangement leads to a problem of degradation in the precision of the waveform shaping. The Non-patent Document 1 proposes a technique for increasing the bandwidth by providing an amplifier having a multistage amplifier configuration as a downstream component of the equalizer. However, such a technique has a problem in that, as the number of amplifier stages is increased, the required circuit area and power consumption also increase.

### SUMMARY OF THE INVENTION

An embodiment of the present invention has been made in view of such a situation. Accordingly, it is an exemplary purpose thereof to provide an adaptive equalizer circuit which provides increased bandwidth by offering a novel approach that differs from those of conventional techniques.
2. Furthermore, the adaptive equalizer circuit described in Non-patent Document 1 compares the output signal from the equalizer with the output signal from the amplifier provided as the downstream component of the equalizer, and feedback-controls the equalizing level based upon the comparison results. However, in such a method, the bandwidth is limited by the amplifier. Accordingly, in some cases, the frequency characteristics of the output signal from the equalizer do not match the frequency characteristics of the output signal from the amplifier, leading to a problem in that the equalization level cannot be optimized.

An embodiment of the present invention has been made in view of such a situation. Accordingly, it is an exemplary purpose thereof to provide an adaptive equalizer circuit which is capable of optimizing the equalization level.

1. An embodiment of the present invention relates to an adaptive equalizer circuit. The adaptive equalizer circuit comprises: an equalizer circuit which amplifies a predetermined bandwidth of an input signal with an adaptive gain; an amplifier which amplifies the output signal of the equalizer circuit; a first filter which allows a predetermined bandwidth of the output signal of the equalizer circuit to pass; a second filter which allows the predetermined bandwidth of the output signal of the amplifier to pass; a first error amplifier which amplifies the difference between the output signal of the first filter and the output signal of the second filter so as to generate an error signal, and controls the gain of the equalizer circuit according to the error signal; and a driver which amplifies the output signal of the equalizer circuit, and outputs the signal thus amplified. The amplifier comprises: first and second transistors with first terminals thereof connected so as to form a common terminal, thereby forming a differential pair; a tail current source which is connected to the first terminal provided as the common terminal of the first and second transistors, and which supplies a tail current; a first resistor provided between a second terminal of the first transistor, which is the opposite terminal of the first terminal thereof, and a fixed voltage terminal; a second resistor provided between a second terminal of the second transistor, which is the opposite terminal of the first terminal thereof, and the fixed voltage terminal; and an adjustment resistor provided between the second terminal of the first transistor and the second terminal of the second transistor. With such an arrangement, the electric potentials at the second terminals of the first and second transistors are output as differential signals. Furthermore, the first filter and the second filter have the same configuration comprising: third and fourth transistors; third and fourth current sources connected to the first terminals of the third and fourth transistors, respectively; an impedance element provided between the first terminals of the third and fourth transistors; a third resistor provided between a second terminal of the third transistor, which is the opposite terminal of the first terminal thereof, and a fixed voltage terminal; and a fourth resistor provided between the second terminal of the fourth transistor, which is the opposite terminal of the first terminal thereof, and the fixed voltage terminal. The electric potentials at the second terminals of the third and fourth transistors are output as differential signals.

With such an embodiment, the amplifier is configured as a single-stage differential amplifier including an adjustment resistor arranged between the second terminals of the differential transistor pair. Thus, such an arrangement provides an increased bandwidth with a reduced circuit area and reduced power consumption. Furthermore, by configuring each of the first and second filters as an active filter, such an arrangement cancels out the reduction in the gain of the amplifier due to the adjustment resistor provided thereto.

Also, the resistance of the adjustment resistor may be set in a range from twice to six times the resistance of the first resistor and the resistance of the second resistor.

Also, each of the first and second filters may be a high-pass filter. Also, the impedance element may be a resistor.

Also, the adaptive equalizer circuit according to the embodiment may further comprise: a third filter which allows a predetermined bandwidth of the output signal of the equalizer circuit to pass; a fourth filter which allows the predetermined bandwidth of the output signal of the amplifier to pass; and a second error amplifier which amplifies the difference between the output signal of the third filter and the output signal of the fourth filter so as to generate an error signal, and controls the gain of the amplifier according to the error signal. Also, the third and fourth filters may have the same configuration as those of the first and second filters.

With such an arrangement, the gain of the amplifier is adjusted such that the component of a predetermined bandwidth of the output signal output from the equalizer matches that output from the amplifier. Thus, such an arrangement provides more suitable waveform shaping.

Also, each of the third and fourth filters may be a low-pass filter. Also, the impedance element included in each of the third and fourth filters may be a capacitor.

Another embodiment of the present invention relates to a selector which connects at least two devices stipulated by the HDMI standard. The selector comprises: multiple adaptive equalizer circuits according to any one of the above-described embodiments, each of which is provided to a corresponding one of multiple channels, and each of which performs waveform shaping for a signal of the corresponding channel; and a multiplexer which receives the outputs of the multiple adaptive equalizer circuits, and selects one from among the outputs thus received.

2. Yet another embodiment of the present invention also relates to an adaptive equalizer circuit. The adaptive equalizer circuit comprises: a first equalizer circuit which amplifies a predetermined bandwidth of an input signal with an adjustable gain; a second equalizer circuit which amplifies a predetermined bandwidth of the output signal of the first equalizer circuit with an adjustable or fixed gain; a driver which amplifies the output signal of the second equalizer circuit, and outputs the output signal thus amplified; an amplifier which amplifies the output signal of the second equalizer circuit; a first filter which allows a predetermined bandwidth of the output signal of the first equalizer circuit to pass; a second filter which allows the predetermined bandwidth of the output signal of the amplifier to pass; and a first error amplifier which amplifies the difference between the output signal of the first filter and the output signal of the second filter so as to generate an error signal, and controls the gain of the first equalizer circuit according to the error signal.

With such an embodiment, the equalizer has a two-stage configuration. The gain (equalizing level) of the equalizer block is controlled by making a comparison between the output signal of the first equalizer circuit provided as the first-stage equalizer and the output signal of the amplifier. By providing the second equalizer circuit provided as the second-stage equalizer and optimizing the characteristics thereof, such an embodiment is capable of preventing degradation of the precision of the waveform shaping due to the frequency characteristics of the gain of the amplifier, or improving the precision of the waveform shaping.

Also, the first error amplifier may control the gain of the second equalizer circuit, in addition to controlling the gain of the first equalizer circuit. Such an arrangement is capable of optimizing the equalizing level with higher precision.

Also, the sensitivity of the gain of the first equalizer circuit in response to the error signal may be higher than the sensitivity of gain of the second equalizer circuit in response to the error signal.

Also, the gain of the second equalizer may contain a component that depends on the error signal and fixed component that does not depend on the error signal.

An adaptive equalizer circuit according to an embodiment may further comprise: a third filter which allows a predetermined bandwidth of the output signal of the second equalizer circuit to pass; a fourth filter which allows a predetermined bandwidth of the output signal of the amplifier to pass; and a second error amplifier which amplifies the difference between the output signals of the third filter and the fourth filter so as to generate an error signal, and controls the gain of the amplifier according to the error signal thus generated.

Yet another embodiment of the present invention relates to a selector which connects at least two devices stipulated by the HDMI standard. The selector comprises: multiple adaptive equalizer circuits according to any one of the above-described embodiments, each of which is provided to a corresponding one of multiple channels, and each of which performs waveform shaping for a signal of the corresponding channel; and a multiplexer which receives the outputs of the multiple adaptive equalizer circuits, and selects one from among the outputs thus received.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows the configuration of an adaptive equalizer circuit according to an embodiment;

FIGS. 2A and 2B are circuit diagrams which show the configurations of an amplifier and a high-pass filter included in the adaptive equalizer circuit shown in FIG. 1;

FIG. 3 is a block diagram which shows the configuration of an adaptive equalizer circuit according to a modification;

FIG. 4 is a block diagram which shows the configuration of an HDMI selector employing an adaptive equalizer circuit according to an embodiment;

FIG. 5 is a block diagram which shows the configuration of an adaptive equalizer circuit according to an embodiment; and

FIG. 6 is a circuit diagram which shows an example configuration of a second equalizer.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B. In the same way, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

### First Embodiment

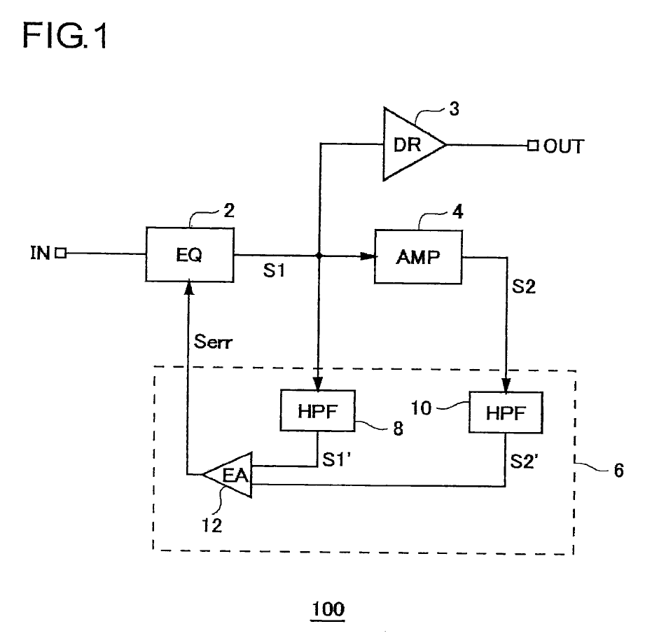

FIG. 1 is a block diagram which shows a configuration of an adaptive equalizer circuit 100 according to a first embodiment. The adaptive equalizer circuit 100 includes an equalizer 2, an amplifier 4, a feedback circuit 6, and a driver 3. In actuality, the blocks shown in FIG. 1 are connected via differential lines. However, FIG. 1 shows a single line for ease of understanding.

For example, the equalizer 2 is a high-frequency emphasis filter, and amplifies a high-frequency component of an input signal IN with an adaptive gain. The driver 3 amplifies an output signal S1 output from the equalizer 2, and generates an output signal OUT.

The amplifier 4 amplifies the output signal S1 of the equalizer 2. The feedback circuit 6 receives the output signal S1 from the equalizer 2 and the output signal S2 from the amplifier 4, and feedback-controls the gain of the equalizer 2 based upon the output signals thus received. The feedback circuit 6 includes a first high-pass filter 8, a second high-pass filter 10, and a first error amplifier 12.

The first high-pass filter 8 and the second high-pass filter 10 respectively allow the high-frequency components of the output signals S1 and S2 to pass, while removing the low-frequency components thereof. Furthermore, the first high-pass filter 8 and the second high-pass filter 10 rectify the output signals S1 and S2 thus allowed to pass, and output the signals S1′ and S2′ thus rectified. The first error amplifier 12 generates an error signal Serr by amplifying the difference between the output signals S1′ and S2′ from the first high-pass filter 8 and the second high-pass filter 10. The gain of the equalizer 2 is controlled according to the error signal Serr.

The above is the overall configuration of the adaptive equalizer circuit 100. The characteristic feature of the first embodiment is that the adaptive equalizer circuit 100 has a configuration including the amplifier 4, the first high-pass filter 8, and the second high-pass filter 10.

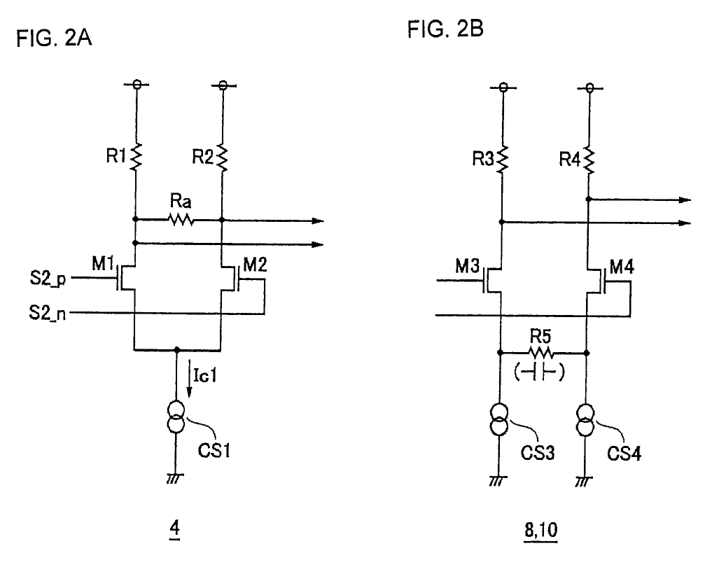

FIGS. 2A and 2B are circuit diagrams which respectively show the configurations of the amplifier 4 of the adaptive equalizer circuit 100 and the high-pass filters 8 and 10 thereof shown in FIG. 1.

As shown in FIG. 2A, the amplifier 4 includes a first transistor M1, a second transistor M2, a first resistor R1, a second resistor R2, an adjustment resistor Ra, and a tail current source CS1.

The first transistor M1 and the second transistor M2 are each N-channel MOSFETs (Metal Oxide Semiconductor Field Effect Transistors). The first terminals (source terminals) of the first transistor M1 and the second transistor M2 are connected to each other so as to form a common source, thereby forming a differential pair. The tail current source CS1 is connected to the first terminal (source terminal) which is the common source thus formed by connecting the first terminals of the first transistor M1 and the second transistor M2. The tail current source CS1 supplies a tail current Ic1 to the first terminal thereof.

The first resistor R1 is provided as a load introduced between a second terminal (drain) which is the opposite terminal of the first terminal (source) of the first transistor M1 and the fixed voltage terminal (power supply terminal). In the same way, the second resistor R2 is provided between a second terminal (drain) of the second transistor M2 and the fixed voltage terminal (power supply terminal).

The adjustment resistor Ra is provided between the second terminal (drain) of the first transistor M1 and the second terminal (drain) of the second transistor M2. The signals that occur at the second terminals (drains) of the first transistor M1 and the second transistor M2 are output as differential signals to a downstream circuit.

The adjustment resistor Ra is provided in order to reduce the impedances of the loads R1 and R2 with respect to the differential pair of the amplifier 4. The adjustment resistor Ra thus provided increases the bandwidth of the amplifier 4. Furthermore, by adjusting the resistance of the adjustment resistor Ra, such an arrangement is capable of adjusting the bias point (DC level) of the differential output, thereby providing the optimum signal level for the second high-pass filter 10 provided as a component downstream of the amplifier 4.

The resistance of the adjustment resistor Ra is preferably set in a range from twice to six times the resistance of the first resistor R1 or the second resistor R2. For example, when the tail current Ic1 is set to around 2 to 6 mA, R1 and R2 should be set to around 100Ω, and Ra should be set to around 400Ω.

Referring to FIG. 2B, the first high-pass filter and the second high-pass filter 10 each have the same configuration. The first high-pass filter 8 and the second high-pass filter 10 each include a third resistor R3, a fourth resistor R4, a third transistor M3, a fourth transistor M4, a third current source CS3, a fourth current source CS4, and a capacitor C3.

Differential signals are input to the gates of the third transistor M3 and the fourth transistor M4. The third current source CS3 and the fourth current source CS4 are connected to the first terminals (source terminals) of the third transistor M3 and the fourth transistor M4, respectively. The third current source CS3 and the fourth current source CS4 each supply a constant current.

A resistor R5 is provided as an impedance element between the first terminal (source) of the third transistor M3 and the first terminal (source) of the fourth transistor M4.

The third resistor R3 is provided between a second terminal (drain) which is the opposite terminal of the first terminal (source) of the third transistor M3 and the fixed voltage terminal (power supply terminal). In the same way, the fourth resistor R4 is provided between the second terminal (drain) of the fourth transistor M4 and the fixed voltage terminal. The high-pass filters 8 and 10 output the electric potentials at the drain terminals of the third transistor M3 and the fourth transistor M4 as differential signals.

As described above, in the adaptive equalizer circuit 100 according to the present embodiment, the first high-pass filter 8 and the second high-pass filter 10 are each configured as differential active filters. That is to say, the first high-pass filter 8 and the second high-pass filter 10 each have their own gain. Thus, as a whole, the adaptive equalizer circuit 100 ensures a sufficient loop gain even if the gain of the amplifier 4 which is an upstream amplifier is low.

With the adaptive equalizer circuit 100 shown in FIG. 1 and FIG. 2, the feedback operation is performed such that the amplitude of the high-frequency component of the output signal S1 matches the amplitude of the high-frequency component of the output signal S2, thereby adjusting the gain of the equalizer 2.

The adjustment resistor Ra provided to the amplifier 4 provides increased bandwidth, thereby increasing the responsivity to changes in the input signal IN. Furthermore, by configuring the first high-pass filter 8 and the second high-pass filter 10 as active filters having their own gain, such an arrangement cancels out the reduction in the gain of the amplifier 4 due to the adjustment resistor Ra provided thereto. Thus, such an arrangement ensures sufficient gain for the feedback loop as a whole.

Furthermore, the amplifier 4 of the adaptive equalizer circuit 100 has a single-stage configuration. Thus, such an arrangement has the advantage of a small circuit area and the advantage of low power consumption.

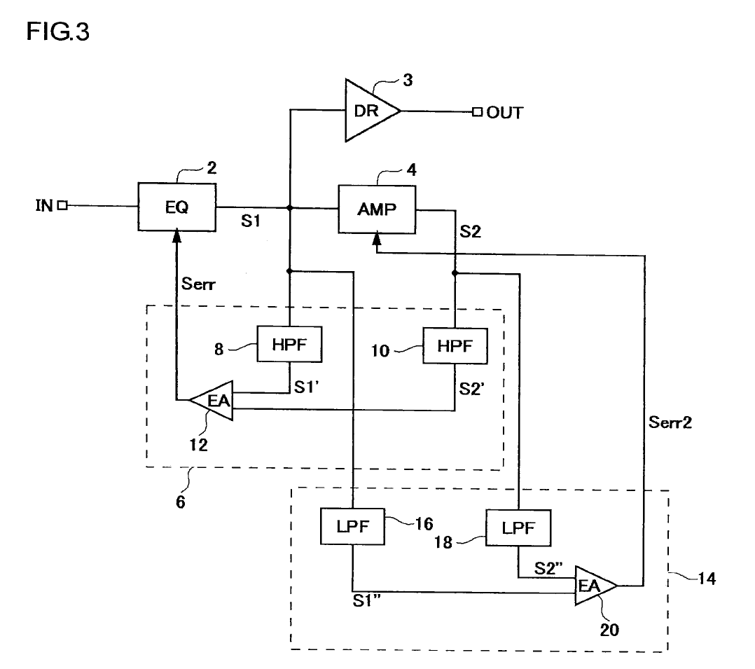

FIG. 3 is a block diagram which shows the configuration of an adaptive equalizer circuit 100a according to a modification. The adaptive equalizer circuit 100a includes a second feedback circuit 14, in addition to the components shown in FIG. 1. The feedback circuit 14 includes a first low-pass filter 16, a second low-pass filter 18, and a second error amplifier 20.

The first low-pass filter 16 and the second low-pass filter 18 respectively allow the low-frequency components of the output signals S1 and S2 to pass. Furthermore, the first low-pass filter 16 and the second low-pass filter 18 rectify the output signals S1 and S2, and output the signals thus rectified. The second error amplifier 20 amplifies the difference between the output signals S1″ and S2″ of the first low-pass filter 16 and the second low-pass filter 18 so as to generate an error signal Serr2, thereby controlling the gain of the amplifier 4 according to the error signal Serr2.

The gain of the amplifier 4 depends on the tail current Ic1 generated by the tail current source CS1 shown in FIG. 2A. Accordingly, the second error amplifier 20 adjusts the gain of the amplifier 4 by controlling the tail current source CS1.

The configurations of the first low-pass filter 16 and the second low-pass filter 18 are basically the same as that shown in FIG. 2B. The point of difference is that, in the configuration of the first low-pass filter 16 and the second low-pass filter 18, instead of the resistor R5, a capacitor is provided between the respective first terminals (source terminals) of the third transistor M3 and the fourth transistor M4.

With the adaptive equalizer circuit 100 shown in FIG. 3, optimal waveform shaping is performed for the input signal IN by adjusting the gain of the amplifier 4 such that the amplitude of the frequency component of the output signal S1 matches that of the output signal S2.

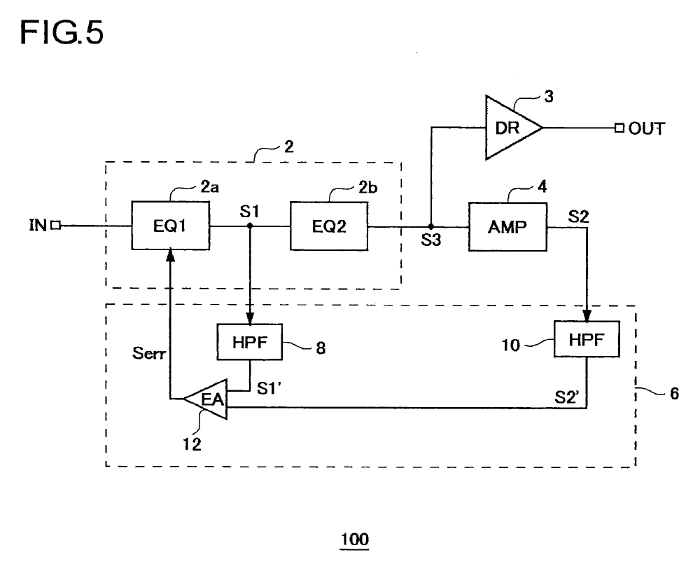

Lastly, description will be made regarding an application of the adaptive equalizer circuit 100 shown in FIG. 1, FIG. 2, and FIG. 5 described later.

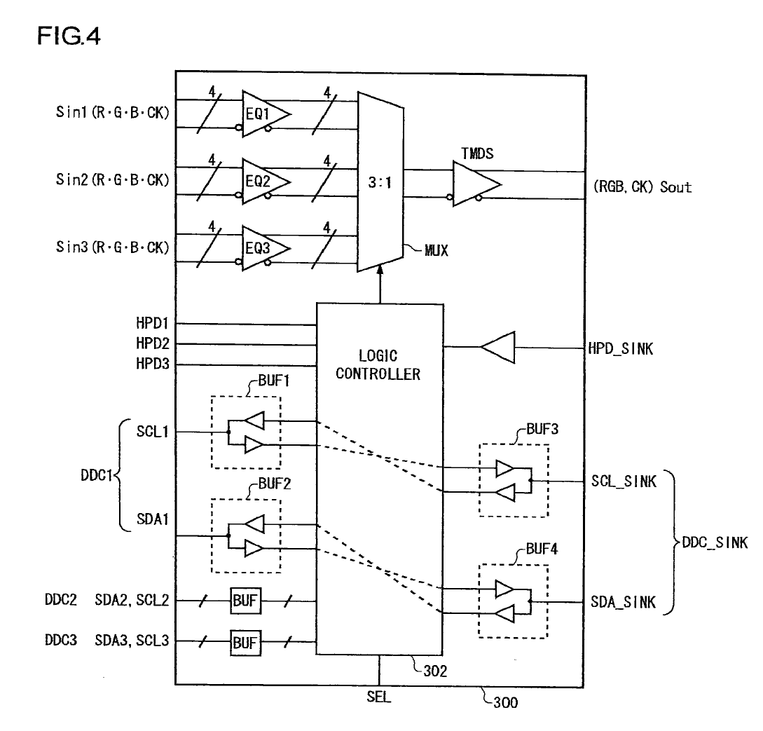

FIG. 4 is a block diagram which shows the configuration of an HDMI selector 300 employing the adaptive equalizer circuit 100 according to an embodiment. The HDMI selector 300 is connected to electronic devices (or electronic circuits) stipulated by the HDMI standard, and switches the input/output paths. The HDMI selector 300 provides a function as a three-to-one multiplexer, and transmits a video/audio signal stipulated by the HDMI standard between any one of the three devices connected to the input side and a single device connected to the output side.

Under the HDMI standard, each channel (cable) is configured as a set comprising a video signal S, a hot plug detection HPD, and a display data channel DDC. Accordingly, three channels (Sin1 through Sin3) are provided on the input side, and a single channel (Sout) is provided on the output side. The video signal S is provided in the form of differential signals including the color luminance signals R, G, and B and a clock CK. Furthermore, equalizers EQ1 through EQ3 are provided on the input side for the signals Sin1 through Sin3, respectively. Each of the equalizers EQ1 through EQ3 provides a function as an input buffer for shaping a dulled waveform by emphasizing a particular frequency component, e.g., a high-frequency component of the differential signals.

The three-to-one multiplexer MUX selects any one of the output signals of the adaptive equalizer circuits EQ1 through EQ3, and outputs the output signal thus selected to a TMDS driver. The TMDS driver outputs, as the signal Sout, the channel thus selected by the multiplexer MUX. In FIG. 4, a set comprising the adaptive equalizer circuits EQ1 through EQ3 and the TMDS driver is provided for each of the luminance signals R, G, and B, and the clock CK.

A logic controller 302 switches the connection channel for the multiplexer MUX according to an external selection signal SEL. Furthermore, the logic controller 302 receives, as input signals, the hot plug detection signals HPD1 through HPD3 for the devices provided on the input side and the hot plug detection signal HPD_SINK for the device provided on the output side.

The display data channels DDC1 through DDC3 each contain information with respect to the corresponding device provided on the input side. The display data channel DDC_SINK contains information with respect to the device provided on the output side. The display data channel for the selected device on the input side is connected to the display data channel for the device on the output side via the logic controller 302. Two-way communication is performed between the input side device and the output side device via the display data channel. An I²C bus is employed as the display data channel. FIG. 4 shows a state in which the display data channel DDC1 is connected to the display data channel DDC_SINK.

The display data channels DDC1 through DDC3 and DDC_SINK each contain a clock SCL and data SDA. Line buffers are provided for each display data channel. For example, focusing attention on the clock signal SCL, a buffer BUF1 for the input side device and a buffer BUF3 for the output side device form a pair, thus forming a two-way buffer. Also, focusing attention on the data signal SDA, a buffer BUF2 for the input side device and a buffer BUF4 for the output side device form a pair, thus forming a two-way buffer. The same can be said of a state in which the data channel DDC2 or DDC3 is connected to the DDC_SINK.

### Second Embodiment

FIG. 5 is a block diagram which shows the configuration of the adaptive equalizer circuit 100 according to a second embodiment. The adaptive equalizer circuit 100 includes an equalizer block 2, an amplifier 4, a feedback circuit 6, and a driver 3. In actuality, the blocks shown in FIG. 5 are connected via differential lines. However, FIG. 5 shows a single line for ease of understanding.

The equalizer block 2 has a two-stage configuration including a first equalizer (pre-equalizer) 2a and a second equalizer (post equalizer) 2b. The first equalizer 2a and the second equalizer 2b are each high-frequency emphasis filters, for example. The first equalizer 2a amplifies the high-frequency component of the input signal IN with an adjustable gain. The second equalizer 2b amplifies the high-frequency component of the output signal S1 of the first equalizer 2a with an adjustable gain or a fixed gain. With such an arrangement, it is assumed that the second equalizer 2b has a variable gain as with the first equalizer 2a.

The driver 3 amplifies the output signal S3 of the second equalizer 2b so as to generate the output signal OUT.

The amplifier 4 amplifies the output signal S3 of the second equalizer 2b. The feedback circuit 6 receives the output signal S3 of the second equalizer 2b and the output signal S2 of the amplifier 4, and feedback-controls the gain of the equalizer block 2 based upon the output signals thus received. The feedback circuit 6 includes a first high-pass filter 8, a second high-pass filter 10, and a first error amplifier 12.

The first high-pass filter 8 and the second high-pass filter 10 allow the high-frequency components of the output signals S1 and S2 to pass, respectively, while removing the low-frequency components thereof. Furthermore, the first high-pass filter 8 and the second high-pass filter rectify the output signals S1 and S2, and output the output signals thus rectified. The first error amplifier 12 amplifies the difference between the output signals S1′ and S2′ from the first high-pass filter 8 and the second high-pass filter 10 so as to generate an error signal Serr, thereby controlling at least the gain of the first equalizer 2a provided as an upstream component, according to the error signal Serr thus generated. In the adaptive equalizer circuit 100 shown in FIG. 5, the first error amplifier 12 also controls the gain of the second equalizer 2b according to the error signal Serr.

The sensitivity α of the gain of the first equalizer 2a in response to the error signal Serr is preferably set to a higher value than the sensitivity β of the gain of the second equalizer 2b in response to the error signal Serr. Specifically, α/β is preferably set in a range from 7/3 to 3/2.

Furthermore, the gain of the second equalizer 2b contains a component that changes the error signal Serr and a component that does not depend on the error signal Serr.

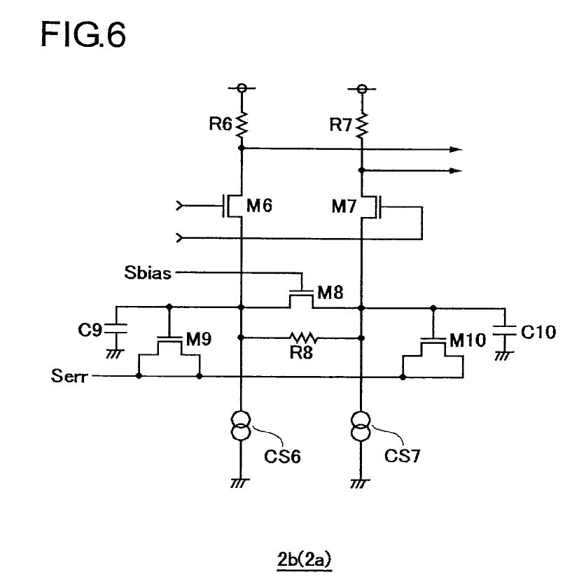

FIG. 6 is a circuit diagram which shows an example configuration of the second equalizer 2b. The second equalizer 2b includes a first transistor M6, a second transistor M7, a first resistor R6, a second resistor R7, a third resistor R8, a first varactor M9, a second varactor M10, a first capacitor C9, a second capacitor C10, a first current source CS6, and a second current source CS7.

Differential signals are input to the gates of the first transistor M6 and the second transistor M7. The first current source CS6 and the second current source CS7 are connected to the first terminals (source terminals) of the first transistor M6 and the second transistor M7, respectively, and each supply a constant current.

The resistor R8 and the third transistor M8 are provided as impedance elements between the first terminal (source) of the first transistor M6 and the first terminal (source) of the second transistor M7. A predetermined bias voltage Sbias is applied to the gate of the third transistor M8. The second equalizer 2b has a DC gain that changes according to the combined impedance of the resistor R8 and the third transistor M8.

The first resistor R6 is provided between a second terminal (drain) of the first transistor M6, which is the opposite terminal of the first terminal (source) thereof, and a fixed voltage terminal (power supply terminal). In the same way, the second resistor R7 is provided between the second terminal (drain) of the second transistor M7 and the fixed voltage terminal.

The first varactor M9 is connected to the source of the first transistor M6. The first varactor M9 is an N-channel MOSFET, the drain and the source of which receive the error signal Serr as the applied voltage and the gate of which is connected to the source of the first transistor M6, and having capacitance in accordance with the error signal Serr.

In the same way, the second varactor M10 is an N-channel MOSFET, the drain and the source of which receive the error signal Serr as the applied voltage, and the gate of which is connected to the source of the second transistor M7, and having capacitance in accordance with the error signal Serr.

The first capacitor C9 is provided between the source of the first transistor M6 and the fixed voltage terminal (ground). The second capacitor C10 is provided between the source of the second transistor M7 and the second capacitor C10.

The second equalizer 2b outputs the electric potentials of the drain terminals of the first transistor M6 and the second transistor M7 as the differential signals.

The gain (equalizing level) of the second equalizer 2b is determined by the combined capacitance of the first varactor M9 and the first capacitor C9 and the combined capacitance of the second varactor M10 and the second capacitor C10. Whereas the capacitances of the first varactor M9 and the second varactor M10 change according to the error signal Serr, the capacitances of the first capacitor C9 and the second capacitor C10 do not depend on the error signal Serr, and are maintained at a constant value. Accordingly, it can be understood that the gain of the second equalizer 2b is composed of a component that changes according to the error signal Serr and a component which does not depend on the error signal Serr.

The first equalizer 2a may have the same configuration as that of the second equalizer 2b shown in FIG. 6, except that the first capacitor C9 and the second capacitor C10 are eliminated.

The areas Sα of the first varactor M9 and the second varactor M10 provided to the first equalizer 2a are parameters which define the sensitivity α of the first equalizer 2a. The ratio between the areas Sβ of the first varactor M9 and the second varactor M10 provided to the second equalizer 2b is a parameter which defines the sensitivity β of the second equalizer 2b.

The above is the configuration of the adaptive equalizer circuit 100. The adaptive equalizer circuit 100 has a configuration in which the equalizers 2 are arranged in a two-stage manner, and the gain (equalizing level) of the equalizer block 2 is controlled by making a comparison between the output signal S1 of the first equalizer 2a provided as an upstream component and the output signal S2 of the amplifier 4. By providing the second equalizer 2b as the second-stage equalizer and by optimizing the characteristics thereof, such an arrangement is capable of preventing degradation of the precision of the waveform shaping due to the frequency characteristics of the gain of the amplifier 4, or improving the precision of the waveform shaping.

A case in which the bandwidth of the gain of the amplifier 4 is insufficient could lead to attenuation of the wideband component of the signal S2, leading to frequency characteristics that differ from those of the original output signal S3. The frequency characteristics of the signal S1 can be adjusted such that it approaches the frequency characteristics of the signal S2 by optimizing the gain ratio between the first equalizer 2a and the second equalizer 2b, specifically, by adjusting the gain of the second equalizer 2b such that it approaches the attenuation rate of the high-frequency component provided by the amplifier 4. Thus, such an arrangement is capable of virtually eliminating the undesired attenuation effects that occur in the amplifier 4.

Lastly, description will be made regarding an application of the adaptive equalizer circuit 100 shown in FIG. 5. The adaptive equalizer circuit 100 can be suitably applied to the HDMI selector 300 shown in FIG. 4.

While the preferred embodiments of the present invention have been described using specific terms, such description is for illustrative purposes only, and it is to be understood that changes and variations may be made without departing from the spirit or scope of the appended claims.

What is claimed is:

1. An adaptive equalizer circuit comprising:
an equalizer circuit which amplifies a predetermined bandwidth of an input signal with an adaptive gain;
a driver which amplifies the output signal of the equalizer circuit, and outputs the signal thus amplified;
an amplifier which amplifies the output signal of the equalizer circuit;
a first filter which allows a predetermined bandwidth of the output signal of the equalizer circuit to pass;
a second filter which allows the predetermined bandwidth of the output signal of the amplifier to pass; and
a first error amplifier which amplifies the difference between the output signal of the first filter and the output signal of the second filter so as to generate an error signal, and controls the gain of the equalizer circuit according to the error signal,
wherein the amplifier comprises
first and second transistors with first terminals thereof connected so as to form a common terminal, thereby forming a differential pair,
a tail current source which is connected to the first terminal provided as the common terminal of the first and second transistors, and which supplies a tail current,
a first resistor provided between a second terminal of the first transistor, which is the opposite terminal of the first terminal thereof, and a fixed voltage terminal,
a second resistor provided between a second terminal of the second transistor, which is the opposite terminal of the first terminal thereof, and the fixed voltage terminal, and
an adjustment resistor provided between the second terminal of the first transistor and the second terminal of the second transistor,
and wherein the electric potentials at the second terminals of the first and second transistors are output as differential signals,
and wherein the first filter and the second filter have the same configuration comprising
third and fourth transistors,
third and fourth current sources connected to the first terminals of the third and fourth transistors, respectively,
an impedance element provided between the first terminals of the third and fourth transistors,
a third resistor provided between a second terminal of the third transistor, which is the opposite terminal of the first terminal thereof, and a fixed voltage terminal, and
a fourth resistor provided between the second terminal of the fourth transistor, which is the opposite terminal of the first terminal thereof, and the fixed voltage terminal,
and wherein the electric potentials at the second terminals of the third and fourth transistors are output as differential signals.

2. An adaptive equalizer circuit according to claim 1, wherein the resistance of the adjustment resistor is set in a range from twice to six times the resistance of the first resistor and the resistance of the second resistor.

3. An adaptive equalizer circuit according to claim 1, wherein each of the first and second filters is a high-pass filter,
and wherein the impedance element is a resistor.

4. An adaptive equalizer circuit according to claim 1, further comprising:
a third filter which allows a predetermined bandwidth of the output signal of the equalizer circuit to pass;
a fourth filter which allows the predetermined bandwidth of the output signal of the amplifier to pass; and
a second error amplifier which amplifies the difference between the output signal of the third filter and the output signal of the fourth filter so as to generate an error signal, and controls the gain of the amplifier according to the error signal,
and wherein the third and fourth filters have the same configuration as those of the first and second filters.

5. An adaptive equalizer circuit according to claim 4, wherein each of the third and fourth filters is a low-pass filter,
and wherein the impedance element included in each of the third and fourth filters is a capacitor.

6. A selector which connects at least two devices stipulated by the HDMI standard, the selector comprising:
a plurality of adaptive equalizer circuits according to claim 1, each of which is provided to a corresponding one of a plurality of channels, and each of which performs waveform shaping for a signal of the corresponding channel; and
a multiplexer which receives the outputs of the plurality of adaptive equalizer circuits, and selects one from among the outputs thus received.

7. An adaptive equalizer circuit comprising:
a first equalizer circuit which amplifies a predetermined bandwidth of an input signal with an adjustable gain;
a second equalizer circuit which amplifies a predetermined bandwidth of the output signal of the first equalizer circuit with an adjustable or fixed gain;
a driver which amplifies the output signal of the second equalizer circuit, and outputs the output signal thus amplified;
an amplifier which amplifies the output signal of the second equalizer circuit;
a first filter which allows a predetermined bandwidth of the output signal of the first equalizer circuit to pass;
a second filter which allows the predetermined bandwidth of the output signal of the amplifier to pass; and
a first error amplifier which amplifies the difference between the output signal of the first filter and the output signal of the second filter so as to generate an error signal, and controls the gain of the first equalizer circuit according to the error signal.

8. An adaptive equalizer according to claim 7, wherein the first error amplifier controls the gain of the second equalizer circuit, in addition to controlling the gain of the first equalizer circuit.

9. An adaptive equalizer circuit according to claim 8, wherein the sensitivity of the gain of the first equalizer circuit in response to the error signal is higher than the sensitivity of gain of the second equalizer circuit in response to the error signal.

10. An adaptive equalizer circuit according to claim 8, wherein the gain of the second equalizer contains a component that depends on the error signal and a fixed component that does not depend on the error signal.

11. A selector which connects at least two devices stipulated by the HDMI standard, the selector comprising:
a plurality of adaptive equalizer circuits according to claim 7, each of which is provided to a corresponding one of a plurality of channels, and each of which performs waveform shaping for a signal of the corresponding channel; and
a multiplexer which receives the outputs of the plurality of adaptive equalizer circuits, and selects one from among the outputs thus received.
